(19) United States
(12) Patent Application Publication
(10) Pub. No.: US 2017/0161792 A1
(43) Pub. Date: Jun. 8, 2017

(54) MEDIA TRADING

(71) Applicants: David Frederick Landsberry, NSW (AU); Ian Charles James, NSW (AU)

(72) Inventors: David Frederick Landsberry, NSW (AU); Ian Charles James, NSW (AU)

(73) Assignee: Media Core Pty Limited, North Sydney (AU)

(21) Appl. No.: 15/433,494

(22) Filed: Feb. 15, 2017

Related U.S. Application Data
(63) Continuation of application No. 12/856,307, filed on Aug. 13, 2010, now abandoned.

(30) Foreign Application Priority Data
Aug. 13, 2009 (AU) AU 2009903802

(51) Int. Cl. G06Q 30/02

(52) U.S. Cl. CPC G06Q 30/0273; H04L 51/046

(57) ABSTRACT

A computer-implemented method for advertisement placement. The method comprises (a) receiving a request of a media buyer to place an advertisement in a requested advertising slot associated with a media owner; (b) automatically determining whether the received request satisfies one or more booking rules to either accept or reject the request, wherein the booking rules are specified by the media owner and associated with the requested advertising slot; and (c) if the request is accepted, sending a request confirmation to the media buyer, but otherwise, determining an alternative advertising slot based on the rejected request and sending an offer of the alternative advertising slot to the media buyer. In other aspects, there are provided computer programs, a media owner system, a media buyer system, a computerized trading platform and a computer system for advertisement placement.

### CROSS-REFERENCE TO RELATED APPLICATION

This application is a continuation of application Ser. No. 12/856,307 filed Aug. 13, 2010.

### TECHNICAL FIELD

The present invention generally concerns media trading, and more particularly computer-implemented methods for advertisement placement in mainstream media such as television. In other aspects, the present invention concerns computer programs, a media owner system, a media buyer system, a computerized trading platform and a computer system for advertisement placement.

### BACKGROUND

Media owners and media buyers operate their own computer systems for the sale and purchase of advertising. For example, a media buyer generally sends an advertisement booking request on an ad hoc basis via email or over a phone call to a media owner. Upon receiving the request, the media owner will then have to manually enter or import the booking request into their system, analyse the booking request and sends an appropriate response to the originating media buyer in a reply email, facsimile or phone.

### SUMMARY OF THE INVENTION

In a first aspect, there is provided a computer-implemented method for advertisement placement, comprising:

(a) receiving a request of a media buyer to place an advertisement in a requested advertising slot associated with a media owner;

(b) automatically determining whether the received request satisfies one or more booking rules to either accept or reject the request, wherein the booking rules are specified by the media owner and associated with the requested advertising slot; and

(c) if the request is accepted, sending a request confirmation to the media buyer, but otherwise, determining an alternative advertising slot based on the rejected request and sending an offer of the alternative advertising slot to the media buyer.

Using the method, media buyers are connected with media owners to streamline the process of media trading process between the buyers and sellers. Once a request is received by the media owner, booking rules specified by the media owner are automatically applied to the request to determine whether the request should be accepted or otherwise. Advantageously, media trading can be performed more efficiently, thereby saving both trading time and costs.

The booking rule may be to determine whether the request comply with one of the following:

availability of the advertising slot;

media owner's restriction on the media buyer;

advertising rate and any applicable discounts;

sponsorship conflict; and

product category conflict.

Alternatively or in addition, the booking rule may be to determine the request satisfy one or more of the following media owner metrics; advertising capacity, released capacity, revenue, advertising volume, revenue budget, revenue target, current revenue level, fill budget, fill target, current fill level, booking pace and advertising cost.

The method may further comprise dynamically updating the booking rule based on one or more of the media owner metrics.

Advantageously, media owners can monitor various metrics in real time to adjust the way they are trading in real time. By dynamically altering booking rules that are used to either accept or reject incoming booking requests, booking rules may be adapted to maximize returns. In this way, media sellers can maintain complete control over their media inventory.

The request may be received from the media buyer and the request confirmation and offer are sent to the media buyer via a computerised trading platform.

The alternative advertising slot may be determined based on one or more criteria of: cost, ratings, reach, frequency, media outlet, advertising period, placement area, date and time of the alternative advertising slot compared with the requested advertising slot.

The method may further comprise adding the rejected request to a queue if the alternative advertising slot is not available in step (c). In this case, the method may further comprise repeating steps (b) and (c) for a fixed number of times once a timeframe associated with the request in the queue expires.

Further, the method may comprise:

receiving a brief specification from the media buyer, the brief specification defined by a date range or budget, or both; and

automatically determining one or more advertising slots that satisfy the brief specification.

In this case, the one or more advertising slots may be are determined based on requirements specified by the media owner, including one or more of: fill target, fill budget, current fill level, restriction on the media buyer, booking pace, actual and estimated ratings, advertising cost, demographic weighting, and contractual agreement between the media buyer and the media owner.

The method may further comprise automatically creating a package of advertising slots for purchase by one or more media buyers. In this case, the package may be automatically created for one or more of: maximizing revenue, meeting budgets, filling availability, satisfying contractual obligations, and providing advertising performance to media buyers.

The created package may then be purchased by a media buyer by agreeing to a set price specified by the media owner within a set period of time, by submitting an offer above a reserve price specified by the media owner or by bidding on the package.

The method further comprise, prior to step (a), assigning a booking priority to the request based on the media buyer or an advertiser associated with the request, and adjusting timing of step (b) based on the booking priority,

In a second aspect, there is provided a computer program stored on a storage medium readable by a computer, wherein the computer program, when executed by the computer, causes the computer to perform the method according to the first aspect.

In a third aspect, there is provided a media owner system operable to perform the method according to the first aspect.

In a fourth aspect, there is provided a computer-implemented method for advertisement placement, comprising:

(a) sending a request for placing an advertisement in a requested advertising slot associated with a media owner; and

(b) receiving either a request confirmation if the request is accepted or an offer of an alternative advertising slot if the request is rejected, wherein the request is automatically accepted or reject based on whether the request satisfies one or more booking rules associated with the media owner or the requested advertising slot, or both.

The method may further comprise analysing a brief specification to automatically create and send the request for placing the advertisement in the requested advertising slot, the brief specification defined by a date range or budget, or both.

In this case, analysing the brief specification may further comprise comparing the brief specification with one or more of metrics: actual ratings, estimated ratings, reach and frequency, reach curves, elemental audience data, advertising costs, availability of advertising slot, and/or any derivation thereof.

In a fifth aspect, there is provided a computer program stored on a storage medium readable by a computer, wherein the computer program, when executed by the computer, causes the computer to perform the method according to the fourth aspect.

In a sixth aspect, there is provided a media buyer system operable to perform the method according to the fourth aspect.

In a seventh aspect, there is provided a computerized trading platform for advertisement placement, the platform comprises a communications hub to communicate media buyers with media owners and operable to:

(a) receive, from a media buyer system associated with a media buyer, a request from for placing an advertisement in a requested advertising slot associated with a media owner,

(b) process and send the received request to a media owner system associated with the media owner; and

(c) receive, from the media owner system, either a request confirmation if the request is accepted or an offer of an alternative advertising slot if the request is rejected, wherein the request is automatically accepted or reject based on whether the request satisfies one or more booking rules associated with the media owner or the requested advertising slot, or both; and

(d) process and send the request confirmation or the offer to the media buyer system associated with the request.

In an eighth aspect, there is provided a computer system for advertisement placement, comprising:

a media owner system operable to perform the method according to the first aspect;

a media buyer system operable to perform the method according to the fifth aspect; and

a computerized trading platform according to the seventh aspect to facilitate real-time communication between the media owner system and media buyer system.

In a further aspect, there is provided a computerized trading platform for placing advertisements in mainstream media such as television, comprising a communications hub to communicate with the buyers and sellers of advertising,

the hub operates to receive a request from a media buyer for one or more advertising slots defined by parameters related to one or more of media seller, media, target demographic, time or space;

the media buyer is first classified based on their contractual arrangements with each media seller;

then the hub processes the request to retrieve details of the advertising slot available to that media buyer classification, surrounding advertising, rates, expected exposure statistics,

the retrieved details is then sent to the media buyer and thereafter updated in real time as changes occur until a booking request is made,

the request is also fed through the media sellers booking rules to determine one or more of the following:
the rate and any applicable discount rules;
the requested program's current fill and revenue levels;
any sponsorship or in-break conflicts; and
position-in-break requests;
   in order to produce a complete advertising brief.

Once the advertising brief is complete, it is automatically returned to the media buyer, either directly or after an approval process, and all the advertising slots in the brief are automatically reserved.

### BRIEF DESCRIPTION OF THE DRAWINGS

Non-limiting example(s) of the invention will now be described with reference to the accompanying drawings, in which:

FIG. 1 is a schematic diagram of an exemplary computer system for advertisement placement.

FIG. 2 is a schematic workflow diagram for creation of brief specification and automatic generation of booking request.

FIG. 3 is a schematic workflow diagram for automated booking request management based on booking rules specified by a media owner.

FIG. 4 is a schematic workflow diagram for booking proposal generation based on booking rules specified by a media owner.

### BEST MODES OF THE INVENTION

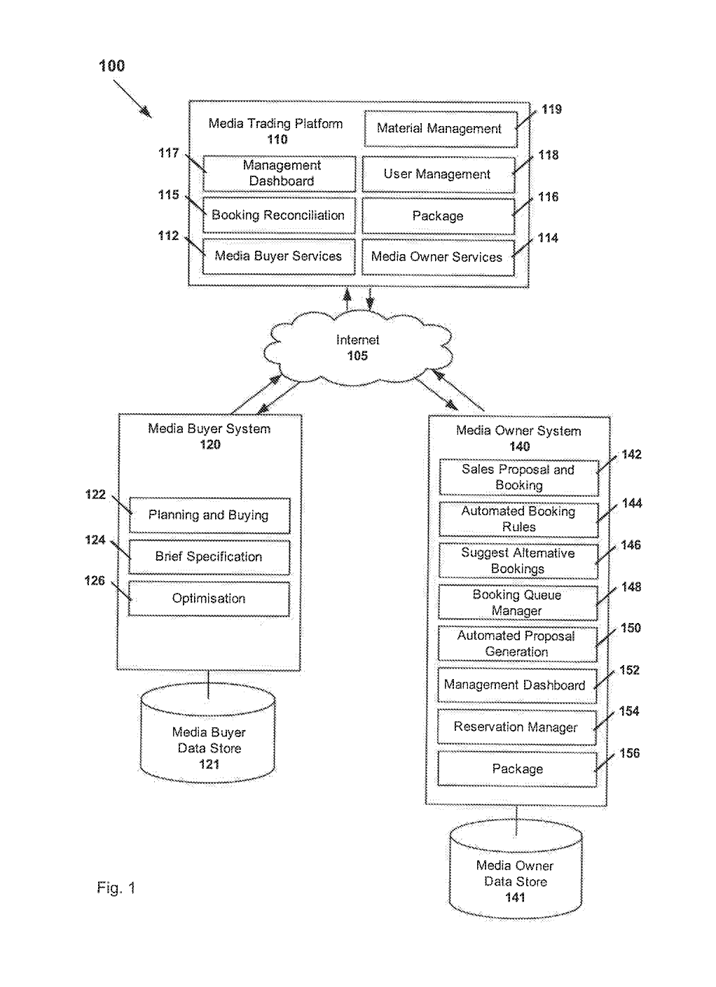

Referring first to FIG. 1, the computer system 100 for advertisement placement comprises a computerized media trading platform 110 that facilitates real-time communication between media buyer systems 120 and media owner systems 140 over a wide area communications network such as the Internet 105. Although only one media buyer system 120 and one media owner system 140 are shown for simplicity, it is noted that there may be plural media buyer systems 120 and media owner systems 140.

The media trading platform 110 is implemented as a communications hub that provides a two-way, real time, end-to-end transactional environment for all interactions and transactions that occur between media buyer systems 120 and media owner systems 140. By allowing media buyers and owners to initiate and complete transactions in real time using the media buyer system 120 and media owner system 140, advertising placement can be performed more efficiently.

The media buyer system 120 provides plural software modules 122-126 that enhance the process of planning and purchasing of advertising from the perspective of a media buyer. Similarly, software modules 142-156 at the media owner system 140 serve to enhance the process of planning and sale of advertising from the perspective of a media owner. The media buyer system 120 and media owner system 140 access a media buyer data store 121 and a media owner data store 141, respectively, to retrieve and store transactional data and other settings.

The system 100 is suitable for, but not limited to, use within the media and advertising industry in any media such as television, radio, newspaper, magazine, website, social networking platforms, billboard, cinema or the like. The media buyer system 120 may be operated by a media buyer such as a creative agency or media agency or advertiser or a representative of the advertiser or any person purchasing advertising. The media owner system 140 may be operated by an employee, sales representative, broker or agency of a media owner or any person selling advertising.

As will be discussed in further detail below, the system 100 in one or more embodiments provides many advantages, including:

The media platform 110 provides a secure platform for transactional exchanges between the media buyer system 120 and the media owner system 140.

Automation and enhancement of the business practices within both media buyer 120 and media owner 140 systems.

Translation facilities of different coding systems used by incompatible media buyer 120 and media owner 140 systems into a centralized industry master system.

Messaging, notification and monitoring facilities between media owner 140 and media buyer 120 systems.

Inherent reconciliation of media owner and media buyer ad booking records, ensuring that both media owner and media buyer views of what has been requested, booked and confirmed are consistent.

The ability to track the lifecycle (history) of ad bookings, booking requests by media buyers, booking proposals by media owners and other interactions between media buyer 120 and media owner 140 systems. For example, a media buyer will be able to see why a particular booking is in their system 120 by following the trail of preceding actions that have led to that booking being created.

Facilities for media owner to promote and sell predefined packages of advertising.

It should be understood that the system 100 in FIG. 1 can also be implemented without the media trading platform 110 by allowing direct communication between the media buyer system 120 and media owner system 140. Also, the media trading platform 110 may implement the software modules 122-126 provided by the media buyer system 120 and/or software modules 142-156 provided by the media owner system 140. Similarly, the media buyer system 120 and media owner system 140 can be configured to implement the software modules 112-119 provided by the media trading platform 110.

The media trading platform 110, media buyer system 120 and media owner system 140 will now be explained in further detail below.

### Media Trading Platform 110

The media trading platform 110 facilitates real-time, two-way transactional exchange traffic between media buyer systems 120 and media owner systems 140. All communication is encrypted for security, such as using Secure Socket Layer (SSL) or similar technology.

### Media Buyer Service 112

The media trading platform 110 provides a set of media buyer services 112 that can be accessed by a media buyer using the media buyer system 120. The services 112 include services that that support each workflow interaction with the media owners. For example, in the case of television advertisement placement, the types of media buyer services include:

TABLE 1
Media Buyer Services

| Media | |
|---|---|
| Buyer Services | Description |
| Request Program | Will request the programming (program name, start |
| Guides | time, end time, genre, classification, etc.) for a |
| | specified date range and list of media outlets (eg: |
| | ATN7, etc.) from one or more media owner |
| | systems 140 |
| Request Rates | Will request the rates for a particular media buyer |
| | and advertiser so that these can be overlaid on the |
| | program guides from one or more media owner |
| | systems 140 |
| Request Program | Will request the estimated ratings for a set of |
| Estimated Ratings | demographics so that these can be overlaid on the |
| | program guides from one or more media owner |
| | systems 140 |
| Request Holdings | Will request holdings from one or more media |
| Information | owner systems 140. Holdings is a file of data that |
| | the media owner can create for each media buyer |
| | that contains all future media owner ad bookings. |
| | This file can be used to perform a full reconciliation |
| | against a media buyer's own system outside of the |
| | media trading platform 110 if required. |
| Request | Will request availability to provide an indication of |
| Availability | whether the media owner(s) may accept bookings |
| | in particular programs on each date from one or |
| | more media owner systems 140 |
| Refresh | Will request a refresh of the availability |
| Availability | information from one or more media owner systems |
| | 140 |
| Send Booking | Will send an ad booking for an advertising slot to |
| | one or more media owner systems 140 |
| Send Booking | Will send a booking request having one or more ad |
| Request | bookings for advertising slots to one or more media |
| | owner systems 140 |
| Change Booking | Will send an ad booking change to one or more |
| | media owner systems 140 |
| Change Booking | Will send a booking request change to one or more |
| Request | media owner systems 140 |
| Cancel Booking | Will send a cancel ad booking to one or more media |
| | owner systems 140 |
| Cancel Booking | Will send a cancel booking request to one or more |
| Request | media owner systems 140 |
| Move Booking | Will request the movement of an ad booking from |
| | one combination of a media buyer, advertiser and |
| | product to another from one or more media owner |
| | systems 140 |
| Request | Will send a request asking for alternative |
| Alternative | booking(s) or advertising slot(s) to be provided that |
| Bookings | offer the same or similar performance in terms of |
| | cost and performance as other booking(s) or |
| | advertising slot(s) to one or more media owner |
| | systems 140 |
| Retrieve Booking | Will request the status of an ad booking for an |
| Status | advertising slot from a media owner system 140 |
| Retrieve Booking | Will request the status of an ad booking request |
| Request Status | from a media owner system 140 |
| Retrieve Bookings | Will retrieve bookings for a specified date range |
| | and list of media outlets for a media buyer, |
| | advertiser, product or campaign from one or more |
| | media owner systems 140 |
| Retrieve Messages | Will retrieve messages and notifications for a media |
| | buyer, advertiser, product or campaign from one or |
| | more media owner systems 140 |
| Submit Brief | Will send a brief specification to one or more media |
| | owner systems 140 |
| Retrieve Brief | Will request the status of a brief from one or more |
| Status | media owner systems 140 |
| Browse Packages | Will retrieve advertising packages of one or more |
| | media owners from the associated media owner |
| | systems 140 |
| Bid for Package | Will place a bid for a package |
| Offer for Package | Will send an offer to purchase a package at a |
| | specified price |
| Buy Now for | Will effect purchase of package at a price specified |
| Package | by the media owner |
| Retrieve Package | Will retrieve historical information related to |
| History | package |

For example, in the case of television advertising, a single ad booking within a booking request generated may be defined by one or more of the following:
(i) Week commencing date of the booking, such as Aug. 10, 2008
(ii) Day placement request of the booking within the week. For example, if a 7 day mask is used to represent the days from Sunday to Saturday then “NYYYYYN” would represent a day placement request of Monday to Friday.
(iii) From time of the booking, such as 1930
(iv) To time of the booking, such as 2029
(v) Program of the booking
(vi) Daypart—such as Prime Time
(vii) Network—the media owner such as Network 7
(viii) Type—the media type such as Metro TV
(ix) Market—Geographic marker such as Sydney or NSW
(x) Channels—Buying Level (such as ATN7) or Aggregated Buying Level (such as PRIME SNSW) or Sub-Channel—Buying Level (such as Prime Canberra)
(xi) Buyer—the media buyer such as Starcom NSW
(xii) Advertiser—the buying advertising company such as Coca Cola
(xiii) Product—the Advertiser's Product such as Coca Cola Light
(xiv) Campaign—the Product's Campaign such as Coke Summer 2010
(xv) Buyer Reference number
(xvi) Gross Actual Rate—the Booking Rate including agency commission for each ad within the Quantity
(xvii) Net Actual Rate—the Booking Rate excluding agency commission for each ad within the Quantity
(xviii) Duration—Booking Duration (usually in seconds). Can be more than one if the booking is for top and tail (such as 30 second ad as first in break and 15 second ad as last in break)
(xix) Quantity—Booking Quantity (number of spots)
(xx) Booking Indicators providing special booking properties/reasons such as Bonus (no charge to the Buyer)
(xxi) Position in Break details—such as first in break request, last in break request, top and tail details, etc.
(xxii) Demographics being targeted such as Men 18+, Women 18+, etc.
(xxiii) Ratings (estimated) for each Demographic such as 100,000 Men 18+ individuals estimated to be reached from a potential of 200,000 Men 18+ individuals
(xxiv) Key Numbers—these are codes for the actual Material (ads) that are to be shown
(xxv) Material Instructions
(xxvi) Comments
(xxvii) Indicator if this is a parent booking that will have other related child ad bookings linked to it
(xxviii) Ad booking links—parent and child
(xxix) Other miscellaneous information such as the user identifier of the booking request originator, date and time the booking was made, name of the booking request originator such as a sales representative for the media buyer, advertiser or product.

### Media Owner Services 114

The media trading platform 110 provides a set of media owner services 114 that can be accessed by a media owner using the media owner system 140. The services 114 include services that support each workflow interaction with media buyers. For example, in the case of television advertisement placement, the types of media owner services 114 include:

TABLE 2
Media Owner Services

| Media | |
|---|---|
| Owner Services | Description |
| Send Booking | Will propose an ad booking for an advertising slot |
| | to a media buyer system 120 |
| Send Booking | Will send a booking proposal having one or more |
| Proposal | ad bookings slot to a media buyer system 120 |
| Change Booking | Will send an ad booking change slot to a media |
| | buyer system 120 |
| Change Booking | Will send a booking proposal change slot to a |
| Proposal | media buyer system 120 |
| Cancel Booking | Will send a cancel ad booking slot to a media buyer |
| | system 120 |
| Cancel Booking | Will send a cancel booking proposal slot to a media |
| Proposal | buyer system 120 |
| Move Booking | Will request the movement of an ad booking from |
| | one combination of a media buyer, advertiser and |
| | product to another slot to a media buyer system 120 |
| Retrieve Booking | Will request the status of an ad booking from one or |
| Status | more media owner systems 140 from the media |
| | trading platform 110 |
| Retrieve Booking | Will request the status of an ad booking proposal |
| Proposal Status | from one or more media owner systems 140 from |
| | the media trading platform 110 |
| Retrieve Bookings | Will retrieve bookings for a specified date range |
| | and list of media outlets for a media buyer, |
| | advertiser, product or campaign from one or more |
| | media owner systems from the media trading |
| | platform 110 |
| Retrieve Messages | Will retrieve messages and notifications for a media |
| | owner, advertiser, product or campaign from the |
| | media trading platform 110 |
| Retrieve Proposal | Will request the status of a proposal from the media |
| Status | trading platform 110 |

### Booking Reconciliation Module 115

The media trading platform 110 provides complete tracking of booking activity including booking requests, booking proposals and booking confirmations between media buyers and media owners, thereby reducing data discrepancies and improving efficiency. Tracking is achieved through the logging data related to all transactions in conjunction with centrally allocated unique identifiers that are attached to each booking request, booking proposal and ad booking. These unique identifiers are also cross linked to both the media owner and media buyer external references.

Specifically, when a booking request is received from the media buyer system 120 or a booking proposal from the media owner system 140, the media trading platform 110 allocates a unique identifier to the booking request. If the booking request or proposal contains more than one ad bookings, the media trading platform 110 allocates a unique identifier to each ad booking. The unique identifiers assigned to booking requests and ad bookings will then be linked with external media buyer and media owner booking references.

The received booking request or proposal, along with their unique identifiers, will then be sent to the relevant media owner 140 and buyer 120 systems such that any future transactional exchange on the same matter can include the same unique identifiers. Advantageously, all relevant parties are able to use the media trading platform 110, media buyer system 120 or media owner system 140 to track the lifecycle of booking requests, booking proposals and/or bookings. Therefore, the media trading platform 110 will now have the sending party's code, the allocated unique identifier and the receiving party's code all cross linked.

The media trading platform 110 also provides synchronisation and notification facilities to ensure media buyer and media owner records of bookings are consistent with their respective internal systems, thereby reducing the need for offline reconciliation. Notification and messaging facilities are provided to store and forward any communication between media owners and media buyers regarding their transactional exchanges. This includes notifications generated by the media trading platform 110 to ensure that pending transactions are attended to by the relevant party and that synchronicity of booking records is maintained between the media owner and media buyer.

The media trading platform 110 also maintains audit logs of all transactions and interactions. Centralized industry master files are maintained and cross-linked with corresponding data in the media buyer 120 and media owner 140 systems. For example, one organization may call Ford the Ford Motor Company, and another may refer to it as Ford Ltd. By creating a central set of industry master files for data such as media buyers, advertisers, products, product categorizations, campaigns, media owners, media outlets such as ATM, genres such as sport, comedy and advertisement types, different coding and referencing systems can be unified. As media buyer and owner organizations submit data to the media trading platform 110 with new codes and new names, these new codes and names will be linked and added into the central master files.

The media trading platform 110 also provides media buyers and owners with the ability to track the lifecycle (history) of ad bookings, booking requests and booking proposals. For example, a media buyer will be able to see why a particular booking is in their system 120 by following the trail of preceding actions that have led to that booking being created.

### Package Module 116

The media trading platform 110 also provides a package module that allows media owners to submit groups of advertising slots as a package and offer the package tier sale on the media trading platform 110. Media buyers can then search for appropriate packages based on specified criteria, bid for the package, offer to purchase the package at a rate, or offer to buy the package at a rate specified by the media owner.

The package module also provides package monitoring and tracking facilities for media owners to monitor, control and analyze their sale process of both current and historical packages. Similarly, the package module provides package search, monitoring and tracking facilities for media buyers to locate appropriate packages of advertising for use in campaigns and to monitor, control and analyze their buying process of both current and historical packages.

### Management Dashboard Module 117

The Management Dashboard module 117 provides reporting facilities that allow media owners to monitor and analyze all activity that is occurring in real time, or that has taken place in a specified timeframe, through the media trading platform 110 and that relates to them.

The reporting facilities also allow media buyers to monitor and analyze all activity 10 that is occurring in real time, or that has taken place in a specified timeframe, through the media trading platform 110 and that relates to them.

### User Management Module 118

The media trading platform 110 also provides a User Management Module 118 controls and manages the media buyer and owner organizations that are allowed to use the platform 110, and users and user roles within the organizations. The media trading platform 110 also controls and manages which organizations can communicate together across the platform 110.

### Material Management Module 119

The Material Management module 119 allows media buyers to specify material and rotation details for ad bookings either at the time of booking or at a later stage. Both media buyers and other authorized third parties such as a creative agency who creates the material, can access the media trading platform 110 to provide material and rotation details on existing ad bookings.

Material is the term used for the actual unique creative execution of an advertisement, such as McDonalds Fast Food advertisement with man walking dog on beach 15 seconds. Rotation is the term used to specify the mix of material to be used when an advertising campaign has more than one piece of material and there is a requirement that the material is applied in a particular mix, such as alternate between 15 and 30 second material versions for each successive showing of an advertisement. This module may also be provided at the media buyer system 120.

Upon receiving the material and rotation details from a media buyer system 120, the media trading platform 110 automatically determines the relevant media owner system that is associated with the details and sends the details to the media owner system 140. Next, a booking record associated with the material and rotation in the data store 141 is then automatically updated by the media owner system 140.

This module 119 further allows a media buyer to send a request to the media trading platform 110 to source third party organizations to create material. Specifically, the module 119 provides an interface for media buyers to submit specifications of material requirements to these organizations. Once material is prepared based on the specifications, the material can be submitted by these organizations to the media trading platform 110 via an interface provided by the module 119. Upon receiving the material, the module 119 automatically manages the return of the material to the instigating user and/or manages the material's distribution to all the relevant media owners.

### Media Buyer System 120

The media buyer system 120 provides the following software modules 122-126 to allow media buyers to interact dynamically with media owners and conduct real time trading via the media trading platform 110.

The media buyer system 120 interfaces in real time with the media trading platform 110 to facilitate planning and buying, transactional exchanges, dynamic data requests, booking reconciliation, brief specification and optimisation. Advantageously, purchase of advertising slots can be performed more efficiently with both cost and time savings.

### Planning and Buying Module 122

The planning and buying module 122 allows media buyers to manage advertising placement with functionalities to allow creation and management of advertising campaigns and preparation of booking requests. This module 122 can be an existing planning and buying system that is used by the media buyer. Using this module 122, a media buyer can create a booking request for an advertising slot consisting of one or more ad bookings.

The planning and buying module 122 interfaces with the media buyer services 112 at the media trading platform 110 to dynamically communicate with a media owner system 140. When used in conjunction with modules such as Automated Booking Rules 144, Suggest Alternative Bookings 146 and Automated Proposal Generation 150 modules, real time responses can be delivered interactively to the media buyer system 120 in an efficient manner.

For example, the planning and buying module 122 can be used to submit a booking 10 request to a media owner system 140 via the media trading platform 110. The Automated Booking Rules module 144 at the media owner system 140 will then process the booking request and creates a booking request response which is sent to the media buyer system 120 via the trading platform. The planning and buying module 122 then automatically formats and presents the response to the user operating the module 122 in real time.

It is therefore an advantage of the media buyer 120 and media owner 140 systems that booking requests and booking proposals can be exchanged directly in real time to facilitate direct and dynamic collaboration in the creation and resolution of an advertising schedule.

The planning and buying module 122 interfaces with the media buyer services 112 provided by the media trading platform 110 to request data from media owner systems 140. The data requested can be used by the planning and buying module 122 to present up-to-date program guides, program estimated ratings, rate cards and holding files to the media buyer.

The data can also be refreshed from time to time. For example, in case of television advertising, the following can be requested:
(i) The future program guides for each television station. The program guides specify the program names and details such as the days and times they will be shown.
(ii) The rate cards specifying types of advertising available and the associated cost for each media buyer, advertiser and product combination.
(iii) Holding files listing all of the future advertisements that a media buyer has made either in totality or for particular advertisers, products and campaigns.

Whenever this data is updated it is necessary for it to be redistributed and updated into a media buyer's system. The media trading platform 110 allows planning and buying module 122 to request this data directly from media owners and have it delivered through the platform 110. Further, the media trading platform 110 provides transactions that can be interactively used within a media buyer's planning and buying module 122 to request the up to date program guides, rate cards, etc. on demand. This ensures that media buyers are working with the latest available data. It also reduces data management requirements at the media buyer end.

Data can be retrieved using a pull or push mechanism, or a combination of both. If a pull mechanism is used, the planning and buying module 122 will send a ‘Retrieve Messages’ transaction to the media trading platform 110 at regular intervals. The platform 110 will then respond with a list of related available notifications. More details related to a specific message or notification can be retrieved if required. If a push mechanism is used, the media trading platform 110 can automatically send messages to the media buyer system 120.

### Brief Specification Module 124

The media buyer system 120 provides a brief specification module 124 that allows media buyers to create a detailed specification of an advertising media brief.

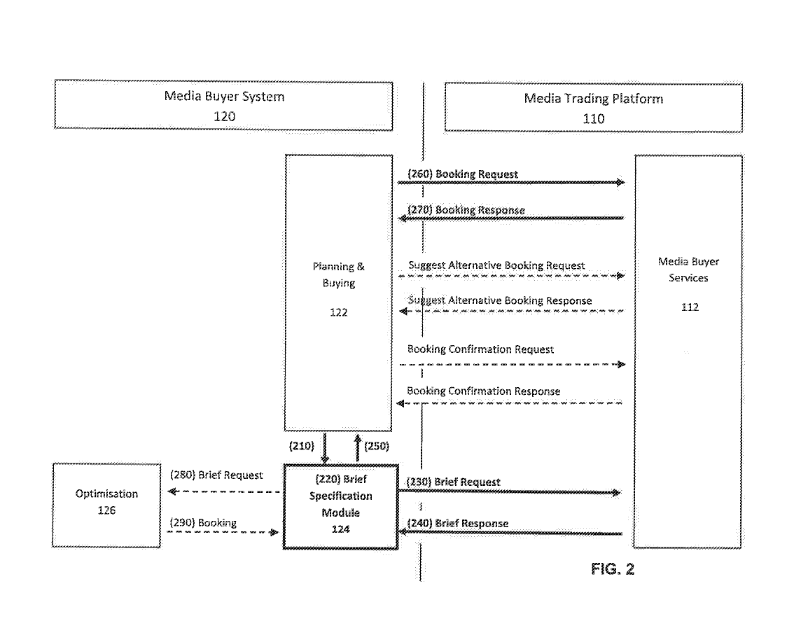

Referring now to FIG. 2, a media buyer first accesses the brief specification module 124 using the planning and buying module 122; see step 210. The brief specification module 124 then creates a brief request based on one or more of the following information provided by the media buyer; see step 220.
(i) Date range into which bookings can be placed
(ii) Target demographics, such as Men 18+ and grocery buyers
(iii) The media types (such as television and radio), markets (such as Sydney, Australia) and media outlets (such as ATN7) to be used
(iv) The placement specifications required, such as day parts for television and radio, sections and segments of a publication for newspapers and magazines
(v) The ad size specifications to be used, such as 30 seconds ads for television, 38×2 column cms for newspapers
(vi) The different creative materials and the rules regarding how these should be applied and rotated to the ads that are proposed
(vii) Desired cost and/or performance metrics. For example, amongst other methods, television ratings can be estimated and measured in TARPs (% of audience exposed to ad) or Thousands (audience exposed to ad expressed in thousands). Based on these estimates and measurements two cost metrics can be derived: CPT (cost divided by TARP) and CPM (cost divided by 000).
(viii) The budget, and how this should be distributed (eg: across days and weeks, media types, markets, media outlets, placements, ad sizes, etc.)
(ix) The required ratings, audience and reach and frequency levels and how these should be achieved across days and weeks, media types, markets, media outlets, placements, ad sizes, etc.
(x) Ad distribution strategy and requirements. For example, in the case of television, the minimum and maximum ads that can be booking in a ½ hour, program, etc.; the maximum ads that can be booked in a single commercial break; etc.
(xi) Minimum and maximum performance metrics for the ads that are being selected such as rate ranges, ratings and audience ranges, rate/ratings (such as measured using CPT and CPM) ranges, incremental performance increase metrics. For example, the brief can specify that no more than 20% of the ads selected should have a rating less than 3.0.
(xii) Placement filters. For example, a television brief specification can include a list of programs that should definitely be considered for ad bookings, and conversely can include a list of programs that should definitely not be considered for ad bookings.
(xiii) The historic data that should be used as the basis for estimating future ratings and reach and frequency.

Once the brief has been prepared, the media buyer system 120 can be operated by a user to submit the brief to the media owner via the media trading platform 110; see step 230 in FIG. 2. In this case the media trading platform 110 will forward the relevant part of the brief specification to each appropriate media owner system 140.

The automated proposal generation module 150 at the media owner system 140 will process the relevant part of the brief specification and reply with one or more booking proposals to the media buyer system 120 via the media trading platform 110; see step 240 in FIG. 2,

The relevant user operating the media buyer system 120 can then review the brief response by the media owner and sends a booking request to the media owner system 140 via the media trading platform 110; see steps 250 and 260 in FIG. 2.

The booking request will be processed by the media owner system 140, which will then reply with a booking response detailing whether each ad booking has been accepted, rejected or queued for further consideration; see step 270 in FIG. 2.

### Optimisation Module 126

Instead of submitting a brief to a media owner system 140, the brief can be submitted to an optimizer or optimisation module 126; see step 280 in FIG. 2. The optimization module 126 automatically analyses the brief's specifications in conjunction with key media buyer metrics and optimisation algorithms to create one or more booking requests that best satisfy the brief whilst meeting media buyer requirements; see step 290 in FIG. 2.

Examples of the type of media buyer metrics utilized by the optimisation module 126 include:

TABLE 3
A Media Buyer's Metrics

| Metric | Description |
|---|---|
| Actual | The number of people that have viewed, listened, read or |
| Ratings | been exposed to the advertising medium or a part of the |
| | advertising medium |
| Estimated | An estimated number of people who might view, listen, |
| Ratings | read or be exposed to the advertising medium or a part of |
| | the advertising medium |
| Reach | The number of different persons exposed to an advertising |
| | medium or part of the advertising medium at least once. |
| | Reach is usually measured over a specific period of time |
| Frequency | The number of times a person will be exposed to an |
| | advertising medium or part of the advertising medium |
| Elemental | Data that allows metrics such as reach and frequency to |
| Audience | be tracked at an individual audience level. In the case of |
| Data | television, the program that the audience watches in |
| | minutes, television station and date. |
| Advertising | Cost of placing advertisement |
| cost | |
| Availability | Whether specific advertising slot(s) are available. This |
| | metric may or may not be provided by the media owner |
| | system 140 |
| Derived | Any derivation of the above. For example, CPT or cost |
| metric | per Target Audience Rating Points (TARP) can be |
| | derived from advertising cost divided by estimated ratings |

When the optimisation module 126 finishes, the booking request(s) generated can be reviewed, further modified and refined in using the planning and buying module 122 if required. The overall brief can also be split into multiple sub-briefs that are optimized independently. The results are then merged with previous ad bookings that have been selected.

Once the media buyer has completed the preparation of the booking request, it can be submitted to the media trading platform 110, which then forward the relevant part of the booking request to each appropriate media owner system 140. Similarly, each media owner system 140 can provide a direct response (through the Automated Booking Rules module 144 at the system 140) to the media buyer indicating if the ad bookings have been accepted, rejected (with or without the media owner providing suggested alternative ad bookings) or queued for further consideration by the media owner.

### Media Owner System 140

The media owner system 140 provides the following software modules to allow media owners to interact dynamically with media buyers and conduct real time trading via the media trading platform 110.

The media owner system 140 interfaces with the media buyer system 120 in real time via the media trading platform 110 to facilitate sales proposal and booking, automated booking request management, automated alternative bookings suggestion, automated proposal generation, booking queue management and reservation management.

### Sales Proposal and Booking Module 142

The Sales Proposal and Booking module 142 allows media owner sales representatives to manage the sale process of advertising. The process generally includes the creation and management of sales proposals consisting of proposed ad bookings, creation and management of ad bookings based on media buyer requirements (including through brief specification), and management and processing of booking requests from media buyers.

### Automated Booking Rules Module 144

The Automated Booking Rules module 144 automatically processes incoming booking requests that are received from media buyers through the media trading platform 110. Using this module 144, booking requests for one or more advertising slots can be processed in real time, with no manual intervention and for an automated response to be provided to the media buyer via the media trading platform 110.

The module 144 is operable to automatically apply a set of media owner booking rules to each advertisement booking request to determine whether the request can be accepted, rejected, queued or forwarded to a sales representative for attention. These booking rules can ensure that ad bookings are only accepted provided they meet the objectives of the media owner.

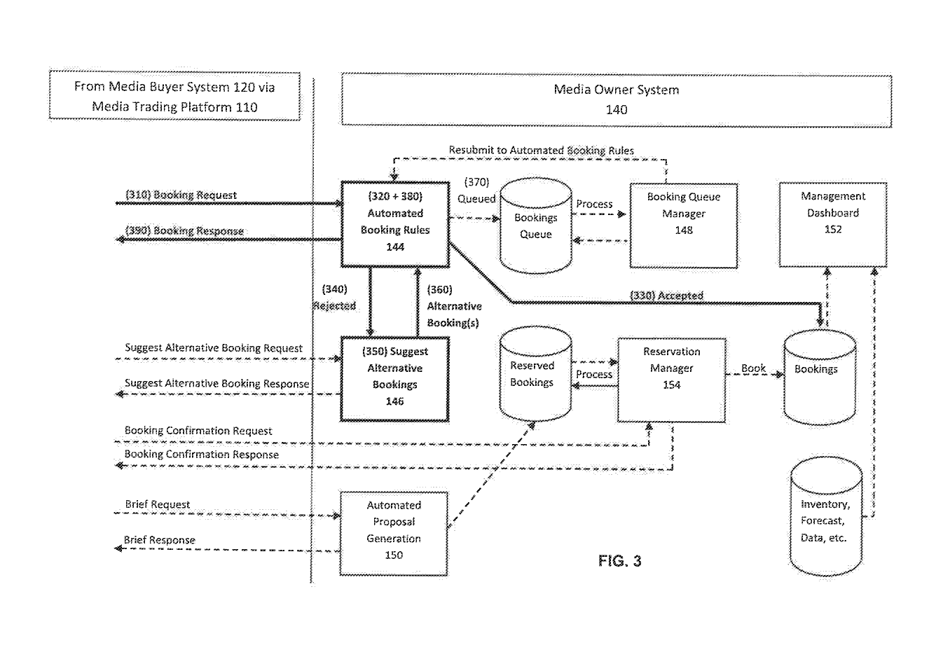

Referring now to FIG. 3, an example of a media buyer system's 120 transaction interaction with a media owner system 140 via the media trading platform 110 will now be described. In this example, the Automated Booking Rules module 144 has been configured to automatically create bookings in a data store if the rule processing results in a booking response of ‘accepted’. Also, an Automated Proposal Generation Module 150 has been configured to automatically reserve booking proposals. Therefore, the media buyer will need to confirm the Proposal Bookings prior to the booking reservation's expiry. Otherwise, a Reservation Manager 154 will automatically remove the Reserved Bookings.

As shown in FIG. 3, a booking request to place an advertisement in a requested advertising slot is first received from a media buyer system 120 via the media trading platform. The booking request may be for one or more advertising slots representing one or more ad bookings. Upon receiving the booking request, the media trading platform 110 processes the booking request and sends it to the appropriate media owner system 140. The Sales Proposal and Booking Module 142 at the media owner system 140 receives the booking request and forwards it to the Automated Booking Rules Module 144; see step 310.

The Automated Booking Rules module 144 retrieves a set of booking rules and determines whether the request for one or more advertising slots satisfies the booking rules; see step 320. There are a number of possible outcomes: (a) accepted, (b) rejected with offer, (c) rejected, (d) queued or (e) forwarded to a user for consideration.

(a) If the request satisfies the booking rules, the module 144 accepts the request using the Sales Proposal and Booking module 142 and a booking record is created and stored in the data store in step 330. The module 144 then updates the status of the request as ‘accepted’ in step 380 and sends a booking confirmation to the media buyer system 120 via the media trading platform 110 in step 390.

(b) If the request is rejected, the request is submitted to the Suggest Alternative Booking module 146 to automatically propose one or more alternative advertising slots; see steps 340, 350 and 360. The module 144 updates the status of the request as ‘rejected with offer’ in step 380 and sends an offer of the alternative advertising slots to the media buyer system 120 via the media trading platform 110 in step 390.

(c) If no alternative advertising slots are provided by the Suggest Alternative Booking module 146 in step 360, the module 144 rejects the request, updates the status of the request as ‘rejected’ in step 380 and sends a booking rejection to the media buyer system 120 via the media trading platform 110 in step 390.

Alternatively, instead of automatically rejecting the request when no alternative advertising slots are available, the module 144 can also be configured to queue the request for later reconsideration or forward the request to a sales representative for attention.

(d) If the request is queued, the Automated Booking Rules module 144 adds the request to a booking queue managed by the Booking Queue Manager 148 for later consideration by the module 144; see step 370. In this case, the module 144 updates the status of the request as ‘queued’ in step 380 and sends a response to the media buyer system 120 via the media trading platform 110 in step 390. For example, the Automated Booking Rules module 144 can be configured to queue a request when a requested advertising slot is available, but the rate offered for the advertising slot is less than a level specified by the media owner.

(e) Finally, the request can also be forwarded to a sales representative of the media owner for further consideration, such as after the request is repeatedly rejected by the Automated Booking Rules module 144. In this case, the module 144 updates the status of the request as ‘forwarded for further consideration’ in step 380 and sends a response to the media buyer system 120 via the media trading platform 110 in step 390.

Advantageously, the media buyer can get a response shortly after a request is submitted. Also, at any time, a media buyer can retrieves the status of a booking request using the planning and buying module 122 on the media buyer system 120, thereby allowing them to track the progress of each booking request.

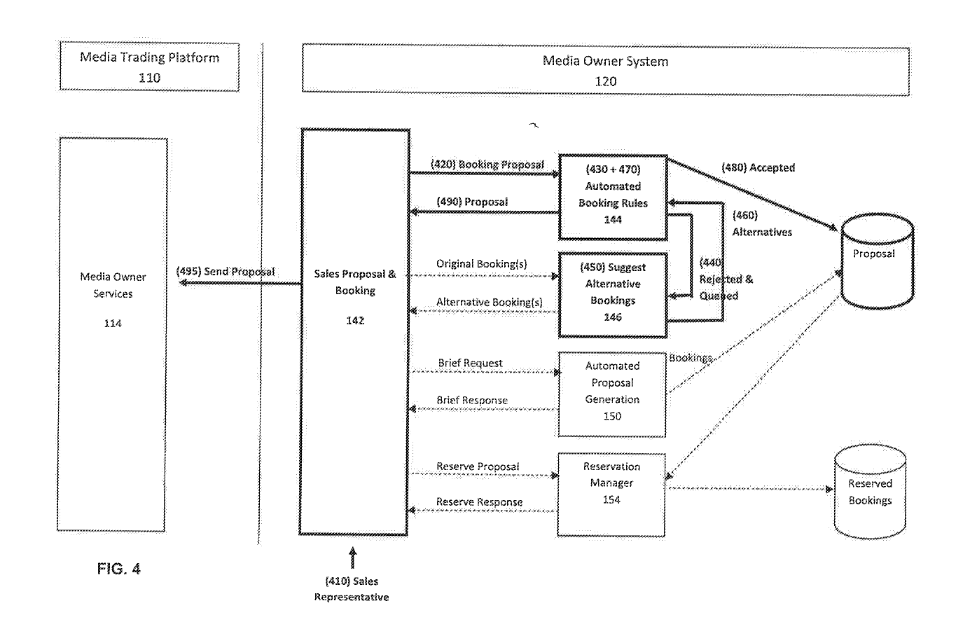

It will be appreciated that the Automated Booking Rules Module 144 can be used regardless of whether a booking request is received from a media buyer system 120. Referring now to FIG. 4, an example of a sales representative using the media owner system 140 to create a booking proposal before sending it to a media buyer will now be described.

The sales representative first accesses the Automated. Booking Rules Module 144 using the sales proposal and booking module 142 to create a booking proposal; see step 410. The sales proposal and booking module 142 forwards the booking proposal to the Automated Booking Rules module 144; see step 420.

In this example, the Automated Booking Rules module 144 processes the booking proposal and a booking status of ‘queued’ is assigned to the proposal; see step 430. The Automated Booking Rules module 144 then forwards the booking proposal to the Suggest Alternative Bookings module 146; see step 440. The Suggest Alternative Bookings module 146 processes the booking proposal and determines a suitable alternative booking or advertising slot; see step 450. The alternative booking is then forwarded to the Automated Booking Rules module 144; see step 460.

The Automated Booking Rules module 144 processes the alternative booking and a Booking status of ‘accepted’ results; see step 470. The booking is then added to the Booking Proposal file in a data store and a response is sent to the Sales Proposal and Booking module 142; see steps 480 and 490. The Sales Representatives can then uses the Sales Proposal and Booking module 142 to send the booking proposal to the media buyer system 120 via the media trading platform 110; see step 495.

The workflow that follows the application of the automated booking rules that can be customized for each booking status. Booking rules applied by the Automated Booking Rules Module 144 can be flexibly customized by each media owner. Customisation can be applied down to the level of the media buyer and/or advertiser and/or product that advertising is being purchased for.

The booking rules include whether the request complies with one or more of the following:
(i) Availability checks to ensure the requested advertising slot is available.
(ii) Further availability restrictions a media owner may place on a particular media buyer and the associated advertiser that they are buying advertising on behalf of. For example, a large media buyer submitting ad bookings on behalf of a large advertiser may have access to more availability than a small media buyer submitting ad bookings on behalf of a small advertiser.
(iii) Validation to ensure the submitted rate is correct and if discounts have been requested, that the discounted rate is within currently acceptable tolerances.
(iv) Validation to ensure that the requested ad placement (such as a television program like 60 Minutes) does not have any restrictions placed on it. For example, the program may have rate restrictions; maximum discount percentages; and overall discount floor.
(v) Sponsorship conflict validation to ensure the requested advertising does not clash with any existing program sponsors. For example, if Coca Cola sponsor a program, they may have the exclusive right to be the only advertiser within the product category of soft drinks that can advertise in the sponsored program.
(vi) Category conflict validation to ensure the requested advertising can be placed into an advertisement break that does not contain advertising for a product within the same product category. For example, Coca Cola advertising may only be able to be placed in an advertisement break that contains no other soft drink advertisements.
(vii) Validation to ensure that placement requests can be fulfilled. For example, this ensures that a request for first advertisement in an advertisement break can be fulfilled in the case of television or a request for back page of publication can be fulfilled for print.
(viii) Validation of the requested advertising against various media owner metrics, such as the current target and budgeted revenue and fill levels associated with the requested booking's ad placement. For example, an ad booking for a specific program may be rejected if the program has already met its target revenue or target fill, an ad booking may be rejected if the rate offered is below a level necessary for the program to eventually make its target revenue.

### Suggest Alternative Bookings Module 146

The Suggest Alternative Bookings Module 146 accepts either a single incoming ad booking, or a set of incoming ad bookings. Its purpose is to use the incoming booking specifications to select one or more alternative ad booking(s) that provide similar cost and performance and that the media owner would be happy to accept; see steps 340, 350 and 360 in FIG. 3 and step 440, 450 and 460 in FIG. 4.

The Suggest Alternative Bookings Module can be flexibly customized by each media owner. These customizations will take into account the characteristics of the ad booking(s) to be replaced and can be applied down to the level of the media buyer and/or advertiser and/or product. The customizations can include:
(i) Settings to specify whether an ad booking can be replaced with only one or more alternative ad bookings
(ii) Settings to specify the importance and priority of cost, ratings and reach and frequency when determining suitable alternative ad booking(s)
(iii) to specify if the ad booking can be replaced with ad booking(s) on the same media outlet (such as channel ATN7) or whether other media outlets can be considered
(iv) Settings to specify if the ad booking can be replaced with ad booking(s) in the same placement area (such as a day part like Prime Time in the case of television) or whether other placement areas can be considered
(v) Settings to specify what advertising periods can be considered for alternative booking(s) (such as same day or week)
(vi) Settings to specify the order that settings will be applied in terms of precedence. For example, attempt to make replacement booking on the same media outlet for the same day and try other placement areas first

The incoming ad booking can also have restrictions attached to it that relate to, and are used in conjunction with the settings above. For example, an incoming ad booking can have restrictions that specify that it can only be replaced with a single booking, on the same station in the same day part.

The Suggest Alternative Booking Module 146 can be automatically invoked whenever there is a requirement to offer alternatives. Some examples of how this module can be integrated are:

When used in conjunction with the Automated Booking Rules Module 144, the Suggest Alternative Booking Module 146 provides an automated mechanism to complete the processing of a booking request when ad bookings get rejected.

The Suggest Alternative Booking Module 146 can be used in various user interface screens throughout the Sales Proposal and Booking system to allow sales representatives dynamic access to this functionality.

The Suggest Alternative Booking Module 146 can be invoked manually by a media buyer through the media trading platform to provide a media buyer with access to this module when alternatives ad booking(s) are required which a media owner would be willing to accept.

### Booking Queue Manager 148

Referring to FIG. 3 again, a booking request can be queued for later consideration; see step 370. The Booking Queue Manager 148 manages a booking queue in which a booking request is ‘placed’ when queued.

When a booking request is submitted to the Booking Queue Manager 148, the request can have properties assigned by the Automated Booking Rules Module 144, such as:
(i) Timeframe that the booking request should sit in the booking queue;
(ii) Process that should be initiated once the timeframe has been reached;
(iii) Retry count, that is the number of times the timeframe and process should be repeated when the process does not result in an accepted booking;
(iv) Action that should be taken after the timeframe expires and the process has been repeated for the amount of times specified in the retry.

For example, when a booking request is placed on the booking queue it has a timeframe of 24 hours assigned to it. The process is to the resubmit the booking to the Automated Booking Rules Module 144. The retry count is 2. The action is to send a reject to the originating media buyer system 120 of the ad booking via the media trading platform 110.

Therefore, in this example, the Booking Queue Manager 148 will submit the booking to the Automated Booking Rules each 24 hours for a further two days. If the booking has still not been accepted within these two days, an automatic reject response will be sent to the originator of the ad booking. If the booking is accepted within these two days, then an automatic booking confirmation will be sent to the media buyer system 120 via the media trading platform 110.

The Booking Queue Manager 148 also includes a user interface. This allows a media owner to change settings for the booking queue, such as to change ad booking properties, resubmit bookings, reorder bookings in the booking queue, override system setting to force bookings to be accepted, run analysis, receive recommendations regarding the affect of accepting queued bookings in terms of the inventory, revenue, fill and yield management.

### Automated Proposal Generator Module 150

The purpose of Automated Proposal Generation module 150 is to create one or more booking proposals that satisfy a brief submitted by a media buyer in an optimized manner for the media owner.

As explained with reference to FIG. 2, the Automated Proposal. Generation module 150 first receives a brief request from the Brief Specification module 124 via the media trading platform 110; see steps 220 and 230 in FIG. 2. The brief request contains detailed specifications which can include one or more of the following:
(i) Date range into which bookings can be placed;
(ii) The budget, and how this should be distributed (eg: across days and weeks, media types, markets, media outlets, placements, ad sizes, etc.);
(iii) Target demographics, such as Men 18+ and grocery buyers;
(iv) The media types (such as television and radio), markets (such as Sydney, Australia) and media outlets (such as ATN7) to be used;
(v) The placement specifications required, such as day parts for television and radio, sections and segments of a publication for newspapers and magazines;
(vi) The ad size specifications to be used, such as 30 seconds ads for television, 38×2 column ems for newspapers;
(vii) The different creative materials and the rules regarding how these should be applied and rotated to the ads that are proposed;
(viii) Desired cost and/or performance metrics. For example, amongst other methods, television ratings can be estimated and measured in TARPs (% of audience exposed to ad) or Thousands (audience exposed to ad expressed in thousands). Based on these estimates and measurements two cost metrics can be derived: CPT (cost divided by TARP) and CPM (cost divided by 000);
(ix) The required ratings, audience and reach and frequency levels and how these should be achieved across days and weeks, media types, markets, media outlets, placements, ad sizes, etc.;
(x) Ad distribution strategy and requirements. For example, in the case of television, the minimum and maximum ads that can be booking in a ½ hour, program, etc.; the maximum ads that can be booked in a single commercial break; etc.;
(xi) Minimum and maximum performance metrics for the ads that are being selected such as rate ranges, ratings and audience ranges, rate/ratings (eg: CPT and CPM) ranges, incremental performance increase metrics. For example, the brief can specify that no more than 20% of the ads selected should have a rating less than 3.0;
(xii) Placement filters. For example, a television brief specification can include a list of programs that should definitely be considered for ad bookings, and conversely can include a list of programs that should definitely not be considered for ad bookings;
(xiii) The historic data that should be used as the basis for estimating future ratings and reach and frequency.

Based on the detailed specification of the brief, the Automated Proposal Generator Module 150 automatically creates one or more booking proposals that best satisfy the brief whilst meeting media owner requirements. The created booking proposal(s) will then be sent to the originating media buyer system 120 via the media trading platform 110.

The media owner requirements considered by the Automated Proposal Generator Module 150 include one or more of the following:
(i) Fill targets, fill budgets and current fill levels. Fill is a measure of how much advertising space has been sold or allocated in relation to the Advertising Inventory (total amount of advertising that could be sold);
(ii) Revenue targets, revenue budgets and current revenue levels;
(iii) Availability of space to place advertising;
(iv) Further availability restrictions the media owner may place on a particular media buyer and the associated advertiser that they are buying advertising on behalf of;
(v) Booking pace, that is the speed at which a program or day part is filling;
(vi) Spreading bookings amongst different cost and performance inventory brackets;
(vii) Actual and estimated ratings, reach and frequency data, reach curves and elemental audience data;
(viii) Advertising cost data;
(ix) Demographic weighting and indexing algorithm to ensure that advertising space is not used if it would be better kept by a media owner to service the advertising requirements for another demographic and campaign. For example, an ad may be a good performing ad for this briefs demographic of Men 18+, however it would be even better to save for another future campaign that is directed at Women 18+;
(x) Derivative metrics created by combining other metrics. For example, advertising cost can be divided by estimated ratings to derive a cost per TARP (CPT) metric;
(xi) Any contractual arrangements that the media owner may have to satisfy in relation to the media buyer and/or advertiser deal.

The Automated Proposal Generation Module 150 can be invoked whenever there is a requirement to generate a proposed set of ad bookings that the media owner would be willing to accept. There are several ways how the Module 150 can be invoked:

The Module 150 can be used in various user interface screens throughout the Sales Proposal and Booking system to allow sales representatives dynamic access to this functionality.

The Module 150 can also be invoked by a media buyer (via a real time transaction) through the media trading platform 110 to provide a media buyer with access to booking proposals without the need for any media owner intervention.

The Module 150 can be used by the media owner to process a batch of brief specifications in one run to ensure optimal allocation of advertising inventory is achieved for the media owner.

### Management Dashboard Module 152

Referring to FIG. 3 again, the Management Dashboard Module 152 provides real time monitoring and reporting of a media owner's inventory, revenue, fill and yield. The module 152 also provides inventory management facilities so that media owners can adjust their trading settings, such as the booking rules used by the Automated Booking Rules Module 144, in response to current trading and inventory conditions.

This module 152 captures the current state of a media owner's system in terms of metrics such as:

TABLE 4
Media Owner's Metrics

| Metric | Description |
|---|---|
| Ratings | The number of people that have viewed, listened, |
| | read or been exposed to the advertising medium or a |
| | part of the advertising medium |
| Fill | A measure of how much advertising space has been |
| | sold or allocated in relation to the advertising |
| | inventory (total amount of advertising that could be |
| | sold) |
| Budget Fill | The amount of Fill that is planned and expected to |
| | be achieved for a advertising medium or a part of |
| | the advertising medium for a period of time |
| Budget Fill Factor | The ratio of Fill to Budget Fill |
| Target Fill | The amount of Fill that is planned and expected to |
| | be achieved at a particular point in time for a |
| | advertising medium or a part of the advertising |
| | medium for a period of time |
| Fill Factor | The ratio of Fill to Target Fill |
| Revenue | The amount of money generated from the sale of |
| | advertising |
| Target Revenue | The amount of Revenue that is planned and |
| | expected to be achieved at a particular point in time |
| | for a advertising medium or a part of the advertising |
| | medium for a period of time |
| Revenue Factor | The ratio of Revenue to Target Revenue |
| Budget Revenue | The amount of Revenue that is planned and |
| | expected to be achieved for a advertising medium or |
| | a part of the advertising medium for a period of |
| | time |
| Budget Revenue | The ratio of Revenue to Budget Revenue |
| Factor | |
| Current Revenue | A measure of current Revenue |
| level | |
| Base Rate | Default cost for advertising |
| Rate Card | The cost of advertising in an advertising medium |
| | for a period of time for the different types of |
| | advertising that can be bought on that advertising |
| | medium. Rate card rates can be negotiated at a |
| | media buyer, advertiser or product level and |
| | override the base rate. |
| Advertising | The amount of advertising space available overall |
| Capacity | |
| Released Capacity | The amount of advertising space currently released |
| | for sale. This is held as an overall released amount, |
| | and also by media buyer/advertiser category |
| | allowing finer control of released capacity based on |
| | the media buyer/advertiser relationships with the |
| | media owner. |
| Current Bookings | Revenue or volume of advertising, such as |
| | measured using seconds in case of television |
| | advertising |
| Booking Pace | A measure of how fast an inventory of advertising |
| | slots is being booked compared to historic base |
| | lines |

These metrics are captured at the lowest level possible. For example, in the case of television the metrics will generally be captured at a television program level. In cases where a particular metric is not available at this lowest level, the module 152 automatically breaks down the higher level metric into a lower level. For example, a daily revenue forecast can be broken down to a set of daily program revenue forecasts based on a weighted time algorithm, or based on a proportion of estimated audience ratings.

Once the current state of the media owner's system has been captured, all further ad booking activities such as new bookings, changes and cancellations are captured in real time, and are used in conjunction with the initial state to provide the media owner with a continuously updated view of their inventory, revenue, till and yield state (Trading State).

The Management Dashboard Module 152 provides media owners with real time facilities to continuously monitor and report the media owner's Trading State based on this dynamically updated data. These facilities include:
(i) Dynamically updated graphical and tabular representations of the Trading State at both macro and micro levels.
(ii) The dashboard can be customized to show and track the information that is currently relevant to the media owner. For example, a bar chart may be placed on a section of the user interface showing actual revenue and forecast revenue for the next 8 weeks for each media outlet. Another section of the user interface could show a list of programs that will not make budget if the current rate card levels are maintained. A third section of the screen may show a pie chart showing the share of the actual revenue written today by media outlet. A fourth section of the user interface may show each ad booking request that is submitted to the system along with its status after passing through the Automated Booking Rules module.
(iii) Ability to interactively adjust the booking rules used by the Automated Booking Rules Module 144 to suit the current levels of demand and supply that are occurring
(iv) Alerts that are customizable by the media owner to advise the media owner of particular trading conditions.
(v) Ability to modify rate cards, allowable discount levels, bonus activity zones (eg: television programs where no cost ads can be placed to sweeten deals), and the like based on supply and demand.
(vi) Ability to adjust the released capacity (both overall and by media buyer/advertiser category).
(vii) Messaging triggers and facilities to automatically send key information to sales representatives. For example, a message to concentrate booking activity in a particular underperforming month. These messages can potentially be distributed as a ticker tape on the sales representative's screens.
(viii) Action triggers that can be automatically activated when particular trading conditions occur. For example, if forecast revenue is reached in a particular section of inventory, the system can automatically place a discount floor (minimum rate rule) on this section of inventory.

Using the Management Dashboard Module 152, media owners can monitor various metrics in real time and adjust the way they are trading in real time by dynamically updating the booking rules. Advantageously, since the Automated Booking Rules Module 144 uses the booking rules to accept, reject, queue or forward incoming requests, the booking rules can be adjusted based on the metrics in Table 4 to meet a certain performance, such as to maximise returns.

### Reservation Manager 154

Referring to FIG. 3 again, the media owner system 140 further comprises a Reservation Manager 154 to manage ad bookings made in Reserve mode. In this case, the Reservation Manager 154 treats the booking as ‘accepted’ and updates all relevant media owner metrics (see Table 4) to reflect this. For example, the current availability is reduced by the booking details and the actual booked metrics such as revenue and fill levels are increased.

The Reservation Manager 154 allows a booking to have the full effect and status in a media owner's system as a normal booking. It further allows time for the reserved bookings to be reviewed without potential to lose the availability to another media buyer or sales representative (on behalf of a media buyer) in the mean time.

When a booking is Reserved, an additional Reservation Time property is attached to it. This property specifies the time that the media buyer has to confirm the booking before it will be automatically reversed out of the system. The Reservation Manager 154 can be used in conjunction with any of the booking mechanisms within the Sales Proposal and Booking Module 142 as per the media owner's requirements.

For example, a media owner can specify that all booking proposals generated by a sales representative through the Automated Proposal Generator will reserve bookings for 2 hours. A media owner could also specify that all booking proposals automatically generated as a result of a media buyer's brief request will reserve bookings for 30 minutes.

The Reservation Manager 154 also includes a user interface to view, manage and analyse reserved bookings. The analysis can consider the bookings that have been reserved in terms of their effect on various metrics such as revenue, fill, yield management and a media owner's exposure.

### Package Module 156

The media owner system 140 further comprises a Package Module 156 that allows the media owner to create a ‘package’ of advertising from one or more media vehicles regardless of the media types. This provides media owners with a powerful new way to create and promote bundles of advertising designed to target particular demographics or across multiple platforms or media types. Metrics, algorithms, modeling techniques, performance curves and calculations can be used during the creation of these packages.

A package can be created using the Package Module 156 with the following parameters:
(i) Package name and description,
(ii) Target demographics,
(iii) How the package will be sold, such as
   Buy Now, where a media buyer can purchase the package at a set price determined by the media owner within a set period of time,
   Offer, where a media buyer must put in an offer above a reserve price specified by the media owner, and
   Bid, where the package is sold to the highest bidding media buyers above a specified reserve at the end of the bid period.
(iv) Key search tags (such as sport, Olympics), dates, placement information (such as Masterchef, Simpsons) and performance criteria (such as estimated 250 ratings Men 18+) that will be used by potential package buyers to identify packages of interest.

The packages can be created manually, or alternatively automatically based on media owner metrics (see Table 4) and additional input specified by the media owner in order to create and promote packages of advertising that will best achieve the media owner goals. For example, a package may be automatically created for maximizing revenue, meeting budgets, filling availability, satisfying contractual obligations, and providing advertising performance to media buyers. This automated package creation can be initiated at will or scheduled to run regularly. This automated package creation can also take into consideration packages that have already been created and how they are performing from a sale and bid viewpoint if they have been published on the Media Trading Platform 110.

Advertising spots can be added to the package via a drag and drop interface with flexible filtering options. As spots increase, the package base rate value is dynamically updated along with performance metrics such as expected ratings, reach and frequency and the overall CPT or CPM. Once an owner has completed the Package setup, the package is published on the Media Trading Platform 110 and will become available to buyers at the scheduled start time.

Media buyers can then browse the created packages using their media buyer system 120. When an appropriate package is located, it can be bought using buy now, an offer or bid made dependent on the type of sale. Both media owners and buyers have full package tracking, monitoring and notification facilities available to them.

Media buyers will be able to search for relevant packages of advertising by entering keyword searches and specifying the categories and genres and performance criteria that they are interested in using their media buyer system 120.

Advantageously, the platform 110 provides the mechanism to manage Packages and the entire sale process including bids, offers and buy transactions, as well as mechanisms for tracking, watching, analyzing, searching, comparing, paying for, accepting payment for and statistics for packages for both media owners and media buyers to aid in the process of buying and selling them.

### APPLICATION EXAMPLES

### Media Buyer's Perspective

An example how the media trading platform 110 operates from a media buyer's side using an example based on Television advertising.

A media buyer, or a media agency representing the media buyer, first creates an advertising campaign using the planning and buying module 122 that interfaces with the media trading platform 110. Otherwise, the media agency or media buyer can use a dedicated planning and buying system that interfaces with the media trading platform 110 via the media buyer system 120.

In this example, a campaign is being created for a 12-week period for Sydney and Melbourne stations. Two demographics are selected—Men 18+ and Men 18-29; the day parts of Prime Time and Late Night have been specified; and the campaign will contain both 15 and 30 second spots.

Once the parameters are set, details of the campaign are sent from the media buyer system 120 to the media trading platform 110. Within seconds the current program guides, rates, estimated ratings and—if the media owner chooses—the “avails” or available advertising slots specifically for this advertiser appear on the media buyer's screen. Their display is constantly updated using the latest information is available at the media buyer system 120.

Each time an advertising slot is booked using a booking request submitted using the planning and buying system 122, the media trading platform 110 processes the request to identify one or more media owners that are associated with the request. The media trading platform 110 then sends the request to the relevant automated booking rules module 144 of the media owners. The automated booking rules module 144 generates an immediate response informing the media buyer system 120 on whether the booking has been accepted, rejected, queued, or forwarded to a sale representative for further consideration by the media owner. In cases where a booking is rejected, the suggest alternative bookings at the media owner system 140 automatically provides alternative avails or advertising slots that, for example, offer similar cost and performance to the media buyer.

In one implementation, the media trading platform 110 can be configured to process transactions in milliseconds to handle, for example, in excess of 70 bookings per second. In this case, the booking volume for 100 stations for a seven day period can be processed in just two hours. Advantageously, this gives media buyers immediate feedback on every booking request, saving significant time waiting for confirmations or advice.

### Media Owner's Perspective

When a booking request for an advertising slot is received by the media owner system 140, the module 144 automatically assigns a Booking Priority based on the agency and advertiser who placed it. This allows media buyers to be classified into like groups based on their contractual arrangements with each media owner.

The booking request, along with its Booking Priority status, is then fed through the media owner's automated booking rules module 144, which then retrieves booking rules associated with the advertising slot. The module 144 consider one or more of the following booking rules:

the avails which have been released for this particular Booking Priority;

the rate and any applicable discount rules;

the requested program's current fill and revenue levels;

any sponsorship or in-break conflicts;

position-in-break requests; and

any other criteria that the media owner may specify.

Advantageously, the automated booking rules module 144 saves the media owner significant time and costs while optimizing all accepted bookings to ensure that media owner-specified requirements such as fill and revenue targets are best met.

### Briefing Process

The media trading platform 110 also simplifies and automates the Briefing process for both media buyers and media owners. In this example, a media buyer may create a brief specification using the Brief Specification Module 124 using, for example, the following:

Brief name;

Overall budget;

Daypart splits;

Required fighting for one or more markers, such as for both the Sydney and Melbourne markets;

Reach goal, such as 3+ reach goal at 30% for each media owner.

In one example, the brief specification may have multiple parts that should be submitted to different media owner systems 140. Once the Brief is submitted by the Brief Specification module 124, the media trading platform 110 determines the relevant media owner systems 140 and directs the appropriate parts of the brief specification to each respective media owner system 140.

When an individual media owner system 140 receives their part of the brief specification, the part is provided to an automated proposal generation module 150. The result is one or more advertising slots that satisfy the received part of the brief specification the satisfy some requirements specified by the media owner while also meeting the media buyer's objectives.

Once the briefing process is completed, a brief response suggesting the advertising slot(s) is automatically sent to the media buyer system 120 via the media trading platform 110. If the media owner wishes, the brief response may be forwarded to an appropriate person for approval first. The automated proposal generation module 150 reserves all selected spots for a set period of time that is determined by the media owner. This allows the media buyer to analyze and further tailor the brief specification, with the assurance that availability is currently there.

### Variations

It will be appreciated by persons skilled in the art that numerous variations and/or modifications may be made to the invention as shown in the specific embodiments without departing from the scope of the invention as broadly described. The present embodiments are, therefore, to be considered in all respects as illustrative and not restrictive.

For example, the media trading platform 110 also facilitates users of Planning and Buying module 122 to collaborate directly with users of Sales Proposal and Booking module 142 in the dynamic creation and resolution of an advertising schedule that can be subsequently submitted as a booking request. The media trading platform 110 allows the advertising schedule to be easily passed between parties as a work in progress and modified as required. Once the advertising schedule has been resolved then either party can submit the resultant booking request to the Automated Booking Rules module 144 and booking confirmations will be sent through the media trading platform 110 to the media buyer.

Further, the system 100 can be extended to include one or more of the following modules:

### Rate Card Creation and Management Module

This module may be included in the media owner system 140. The purpose is to create and manage Rate Cards for an advertising medium, or part of the advertising medium. The module uses a series of algorithms, historic data, modeling techniques, external data sources, metrics (see Table 4) in combination with some manual intervention (such as know-hobs and gut feel) as inputs.

The module incorporates tracking, monitoring and alarms so that rate cards can be continually monitored and potentially adjusted in relation to how the parts of a media vehicle is performing in terms of metrics and other measures.

### Snapshot Module

This module may be included in the media owner system 140. This module will be run at regular intervals (generally each evening) and will snapshot the current version of relevant Metrics and store them so that they can be used in algorithms and modeling processes of other modules.

Fill and Revenue Predictions

This module may be included in the media owner system 140. The purpose of this module is to create and manage Budgeted Fill, Target Fill, Budgeted Revenue, Target Revenue for a media vehicle or part of a media vehicle. Target Fill and Target Revenue generally change as we draw closer to the time when the advertising is actually shown, played, published or printed, and this module takes this into account and determines Target Fill and Target Revenue at various points of time in advance of the advertising actually occurring so that progress can be monitored and performance compared at any time in advance.

This module uses a series of algorithms, historic data, modeling techniques, external data sources, Metrics in combination with some manual intervention (ie: know-how and gut feel) as inputs. This module also incorporates tracking, monitoring and alarms so that Budgeted Fill, Target Fill, Budgeted Revenue, Target Revenue can be continually monitored and potentially adjusted in relation to how the parts of a media vehicle is performing in terms of Metrics and other measures.

### Campaign Tracking Module

This module may be provided at the media trading platform 110 and/or media buyer system 120 and/or media owner system 140. This module keeps track of a campaign, a set of campaigns or all campaigns and how they are tracking in terms of performance in relation to cost and Ratings. It includes top level summary information with drilldown capabilities, alarms and notifications and can potentially invoke systems to attempt to make adjustments to a campaign to increase delivery in terms of cost and performance including Ratings.

### Post Analysis Module

This module may be provided at the media trading platform 110 and/or media buyer system 120 and/or media owner system 140. This Post Analysis module loads and maintains industry research data such as Ratings and Advertising Occurrence data and uses this data to apply against Bookings to check that they actually were placed and compares actual performance in terms of Ratings to estimated performance in terms of Ratings. This module incorporates a cross coding system so that the external data can be correctly linked to the media owner and Media Buyer data via an interface.

There is also a reconciliation process that occurs where discrepancies are accounted for so that the advertising bills that are produced by media owners for Media Buyers contains only bookings that were actually placed.

### Event Calendar

This module may be provided at the media trading platform 110, media buyer system 120 or media owner system 140. Event calendar allows special events, time periods and special periods to be marked in a central calendar and for detailed notes to also be added. Any other module in the system that utilizes dates can utilize this calendar so that the details of special events, time periods and special periods can be highlighted and be available in these other modules. This allows users and other modules the flexibility to take into account the potential affects that historic special events, time periods and special periods may have had on Metrics, or the affects that future special events, time periods and special periods may have on Metrics.

### Ratings Prediction

This module may be provided at the media trading platform 110 and/or media buyer system 120 and/or media owner system 140. The purpose of the Ratings Prediction Module is to predict Ratings for a media vehicle or part of a media vehicle. This module uses a series of algorithms, historic data, modeling techniques, external data sources, Metrics in combination with some manual intervention (ie: know-how and gut feel) as inputs. This module incorporates tracking, monitoring and alarms so that ratings can be continually refined as more information is available.

### Program Guide Creation and Management Module

This module may be provided at the media trading platform 110 and/or media buyer system 120 and/or media owner system 140. This module allows the creation of Program Guides specifying what programs should be shown when and on what media vehicles for different periods of time. This module uses various system metrics, data and modeling to achieve this.

### Promo Placement

This module may be provided at the media trading platform 110 and/or media buyer system 120 and/or media owner system 140. This Promo Placement Module performs optimization of promotion schedules for a media owner (and cross promotional schedules where a media owner owns multiple media vehicles) in a similar fashion to the Sales Proposal and Booking module 142. This Promo Placement module also has to consider that even though there is no cost associated with placing promotions, there is an opportunity cost associated with their placement.

### Others

It should also be understood that, unless specifically stated otherwise as apparent from the following discussion, it is appreciated that throughout the description, discussions utilizing terms such as “receiving”, “processing”, “retrieving”, “selecting”, “calculating”, “determining”, “displaying” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices.

It should also be understood that the methods and systems described might be implemented on many different types of processing devices by computer program or program code comprising program instructions that are executable by one or more processors. The computer program instructions may include source code, object code, machine code or any other stored data that is operable to cause a processing system to perform the methods described. The computer program can be written in any form of programming language, including compiled or interpreted languages and can be deployed in any form, including as a stand-alone program or as a module, component, subroutine or other unit suitable for use in a computing environment. The computer program can be executed on one computer or on a multiple computers at one site or distributed across multiple sites and interconnected by a communication network.

It should also be understood that the methods and systems may be provided on any suitable computer readable media. Suitable computer readable media may include volatile (e.g. RAM) and/or non-volatile (e.g. ROM, disk) memory, carrier waves and transmission media (e.g. copper wire, coaxial cable, fibre optic media). Exemplary carrier waves may take the form of electrical, electromagnetic or optical signals conveying digital data steams along a local network or a publically accessible network such as the Internet. Computer components, processing units, engines, software modules, functions and/or data structures described herein may be connected directly or indirectly to each other in order to allow any data flow required for their operations. It is also noted that software instructions or module can be implemented using various of methods. For example, a subroutine unit of code, a software function, an object in an object-oriented programming environment, an applet, a computer script, computer code or firmware can be used. The software components and/or functionality may be located on a single device or distributed over multiple devices depending on the application.

Reference in the specification to “one embodiment” or “an embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment. Unless the context clearly requires otherwise, words using singular or plural number also include the plural or singular number respectively.

1. A computer-implemented method for advertisement placement, comprising:
(a) receiving a request of a media buyer to place an advertisement in a requested advertising slot associated with a media owner;
(b) automatically determining whether the received request satisfies one or more booking rules to either accept or reject the request, wherein the booking rules are specified by the media owner and associated with the requested advertising slot; and
(c) if the request is accepted, sending a request confirmation to the media buyer, but otherwise, determining an alternative advertising slot based on the rejected request and sending an offer of the alternative advertising slot to the media buyer.

2. The method of claim 1, wherein the booking rule is to determine whether the request comply with one of the following;
availability of the advertising slot;
media owner's restriction on the media buyer;
advertising rate and any applicable discounts;
sponsorship conflict; and
product category conflict.

3. The method of claim 1, wherein the booking rule is to determine the request satisfy one or more of the following media owner metrics: advertising capacity, released capacity, revenue, advertising volume, revenue budget, revenue target, current revenue level, fill budget, fill target, current fill level, booking pace and advertising cost.

4. The method of claim 3, further comprising dynamically updating the booking rule based on one or more of the media owner metrics.

5. The method of claim 1, wherein the request is received from the media buyer and the request confirmation and offer are sent to the media buyer via a computerised trading platform.

6. The method of claim 1, wherein the alternative advertising slot is determined based on one or more criteria of: cost, ratings, reach, frequency, media outlet, advertising period, placement area, date and time of the alternative advertising slot compared with the requested advertising slot.

7. The method of claim 1, further comprising adding the rejected request to a queue if the alternative advertising slot is not available in step (c).

8. The method of claim 7, further comprising repeating steps (b) and (c) for a fixed number of times once a timeframe associated with the request in the queue expires.

9. The method of claim 1, further comprising:
receiving a brief specification from the media buyer, the brief specification defined by a date range or budget, or both; and
automatically determining one or more advertising slots that satisfy the brief specification.

10. The method of claim 9, wherein the one or more advertising slots are determined based on requirements specified by the media owner, including one or more of: fill target, fill budget, current fill level, restriction on the media buyer, booking pace, actual and estimated ratings, advertising cost, demographic weighting, and contractual agreement between the media buyer and the media owner.

11. The method of claim 1, further comprising automatically creating a package of advertising slots for purchase by one or more media buyers.

12. The method of claim 11, wherein the package is automatically created for one or more of: maximizing revenue, meeting budgets, filling availability, satisfying contractual obligations, and providing advertising performance to media buyers.

13. The method of claim 11, wherein the created package can be purchased by a media buyer by agreeing to a set price specified by the media owner within a set period of time, by submitting an offer above a reserve price specified by the media owner or by bidding on the package.

14. The method of claim 1, further comprising, prior to step (a), assigning a booking priority to the request based on the media buyer or an advertiser associated with the request, and adjusting timing of step (b) based on the booking priority.

15. A computer program stored on a storage medium readable by a computer, wherein the computer program, when executed by the computer, causes the computer to perform the method according to claim 1.

16. A media owner system operable to perform the method according to claim 1.

17. A computer-implemented method for advertisement placement, comprising:
(a) sending a request for placing an advertisement in a requested advertising slot associated with a media owner; and
(b) receiving either a request confirmation if the request is accepted or an offer of an alternative advertising slot if the request is rejected, wherein the request is automatically accepted or reject based on whether the request satisfies one or more booking rules associated with the media owner or the requested advertising slot, or both.

18. The method of claim 17, further comprising analysing a brief specification to automatically create and send the request for placing the advertisement in the requested advertising slot, the brief specification defined by a date range or budget, or both.

19. The method of claim 18, wherein analysing the brief specification further comprises comparing the brief specification with one or more of metrics: actual ratings, estimated ratings, reach and frequency, reach curves, elemental audience data, advertising costs, availability of advertising slot, and/or any derivation thereof.

20. A computer program stored on a storage medium readable by a computer, wherein the computer program, when executed by the computer, causes the computer to perform the method according to claim 17.

21. A media buyer system operable to perform the method according to claim 17.

22. A computerized trading platform for advertisement placement, the platform comprises a communications huh to communicate media buyers with media owners and operable to:
(a) receive, from a media buyer system associated with a media buyer, a request from for placing an advertisement in a requested advertising slot associated with a media owner,
(b) process and send the received request to a media owner system associated with the media owner; and
(c) receive, from the media owner system, either a request confirmation if the request is accepted or an offer of an alternative advertising slot if the request is rejected, wherein the request is automatically accepted or reject based on whether the request satisfies one or more booking rules associated with the media owner or the requested advertising slot, or both; and
(d) process and send the request confirmation or the offer to the media buyer system associated with the request.

23. A computer system for advertisement placement, comprising:
a media owner system operable to perform the method comprising
(a) receiving a request of a media buyer to place an advertisement in a requested advertising slot associated with a media owner;
(b) automatically determining whether the received request satisfies one or more booking rules to either accept or reject the request, wherein the booking rules are specified by the media owner and associated with the requested advertising slot; and
(c) if the request is accepted, sending a request confirmation to the media buyer, but otherwise, determining an alternative advertising slot based on the rejected request and sending an offer of the alternative advertising slot to the media buyer;
a media buyer system operable to perform the method comprising
(a) sending a request for placing an advertisement in a requested advertising slot associated with a media owner; and
(b) receiving either a request confirmation if the request is accepted or an offer of an alternative advertising slot if the request is rejected, wherein the request is automatically accepted or reject based on whether the request satisfies one or more booking rules associated with the media owner or the requested advertising slot, or both; and
a computerized trading platform comprising a communications hub to communicate media buyers with media owners and operable to:
(a) receive, from a media buyer system associated with a media buyer, a request from for placing an advertisement in a requested advertising slot associated with a media owner,
(b) process and send the received request to a media owner system associated with the media owner; and
(c) receive, from the media owner system, either a request confirmation if the request is accepted or an offer of an alternative advertising slot if the request is rejected, wherein the request is automatically accepted or reject based on whether the request satisfies one or more booking rules associated with the media owner or the requested advertising slot, or both; and
(d) process and send the request confirmation or the offer to the media buyer system associated with the request,
to facilitate real-time communication between the media owner system and media buyer system.

24. The method of claim 12, wherein the created package can be purchased by a media buyer by agreeing to a set price specified by the media owner within a set period of time, by submitting an offer above a reserve price specified by the media owner or by bidding on the package.
